(19) United States
(12) Patent Application Publication
(10) Pub. No.: US 2006/0110950 A1
(43) Pub. Date: May 25, 2006

(54) Connector in which a stress applied upon connection is received by a contact

(75) Inventors: Naofumi Ikenaga, Tokyo (JP); Takaaki Kudo, Tokyo (JP)

Correspondence Address: WILLIAM COLLARD;COLLARD & ROE, P.C., 1077 NORTHERN BOULEVARD, ROSLYN, NY, 11576, US

(73) Assignee: JAPAN AVIATION ELECTRONICS INDUSTRY, LIMITED

(21) Appl. No.: 11/285,869

(22) Filed: Nov. 23, 2005

(30) Foreign Application Priority Data
Nov. 24, 2004 (JP) 2004-339427

(51) Int. Cl. H01R 12/00

(52) U.S. Cl. 439/67

(57) ABSTRACT

In a connector including first and second contacts to be connected to a connection object and a housing holding the first and the second contacts, an actuator has a cam movable with respect to the housing between a connecting position of the connection object and a disconnecting position of the connection object. The first contact has a first contacting portion with a first contact point and a pivot portion operated by the cam. The second contact has a second contacting portion with a second contact point and a butting portion faced to the second contacting portion. The butting portion clamps the connection object in cooperation with the first contact point when the connector is connected to the connection object.

This application claims priority to prior Japanese application JP 2004-339427, the disclosure of which is incorporated herein by reference.

### BACKGROUND OF THE INVENTION

This invention relates to a connector to be connected to a flexible printed circuit board (FPC) or the like.

A connector of the type is disclosed, for example, in Japanese Unexamined Patent Application Publication (JP-A) No. H9-97655. Referring to FIGS. 1 and 2, the connector will be described.

The connector depicted at 21 in the figures comprises a number of first contacts 23 held by a housing 22 and arranged adjacent to and in parallel to one another at a predetermined pitch to form a single row in a direction perpendicular to a drawing sheet. Similarly, a number of second contacts 24 are held by the housing 22 and arranged adjacent to and in parallel to one another at a predetermined pitch to form a single row in the direction perpendicular to the drawing sheet. The connector 21 also comprises an actuator 25 held by the housing 22 to be rotatable in a range of 90 degrees. FIG. 1 shows the actuator 25 in an opened position. FIG. 2 shows the actuator 25 in a closed position.

Each of the first contacts 23 has a pivot portion 23a elastically deformable, a contacting portion 23b faced to the pivot portion 23a, a connecting portion 23c connected to the pivot portion 23a and the contacting portion 23b, a fixing portion 23d connected to the connecting portion 23c and fixed to the housing 22, and a terminal portion 23e connected to the connecting portion 23c. The pivot portion 23a and the contacting portion 23b extend from the connecting portion 23c as two branched parts. The pivot portion 23a has an engaging recess 23a1 formed near its end to be engaged with a cam 25a at an end of the actuator 25. The contacting portion 23b has a contact point 23b1 formed near its end to be connected to a FPC 31. The actuator 25 has a recess 25b formed near the cam 25a at its end. FIG. 1 shows a state where the FPC 31 is inserted into the connector 21 and the actuator 25 is in the opened position.

The actuator 25 is rotated counterclockwise by 90 degrees from the opened position in FIG. 1 into the closed position in FIG. 2. In this event, the cam 25a pushes the pivot portion 23a upward so that the contact point 23b1 of the contacting portion 23b presses the FPC 31 in the direction depicted by the arrow. As a consequence, the housing 22 in contact with the FPC 31 is applied with a stress.

Another connector of the type is disclosed also in Japanese Unexamined Patent Application Publication (JP-A) No. 2001-76794.

In recent years, a connector is desired to have a low profile as one factor of a small size. However, if a housing (insulator) is reduced in thickness in order to achieve the low profile of the connector, a part of the insulator which is applied with a stress is easily deformable. This results in a disadvantage that connection between a contact of the connector and a connection object such as a FPC becomes unstable.

### SUMMARY OF THE INVENTION

It is therefore an object of this invention to provide a connector capable of establishing stable connection between a contact of the connector and a connection object such as a FPC even if the connector has a low profile.

Other objects of the present invention will become clear as the description proceeds.

According to an aspect of the present invention, there is provided a connector comprising first and second contacts to be connected to a connection object, a housing holding the first and the second contacts, and an actuator having a cam movable with respect to the housing between a connecting position of the connection object and a disconnecting position of the connection object, the first contact having a first contacting portion with a first contact point and a pivot portion operated by the cam, the second contact having a second contacting portion with a second contact point and a butting portion faced to the second contacting portion, the butting portion clamping the connection object in cooperation with the first contact point when the connector is connected to the connection object.

### BRIEF DESCRIPTION OF THE DRAWINGS

FIG. 1 is a sectional view of a conventional connector in a state where a FPC is inserted therein and an actuator is opened;

FIG. 2 is a sectional view of the connector in FIG. 1 in a state where the FPC is inserted therein and the actuator is opened;

FIG. 3 is a perspective view of a connector according to an embodiment of this invention;

FIG. 4 is a perspective view of the connector in FIG. 3 with a part of an actuator cut away;

FIG. 5 is a sectional view of the connector in FIG. 3 at a position where a whole of a first contact is seen;

FIG. 6 is a sectional view of the connector in FIG. 3 at a position where a whole of a second contact is seen;

FIG. 7 is a sectional view similar to FIG. 5 in a state where a FPC is inserted into the connector;

FIG. 8 is a sectional view similar to FIG. 6 in a state where the FPC is inserted into the connector;

FIG. 9 is a perspective view of the connector in FIG. 3 in a state where the actuator is closed after the FPC is inserted into the connector;

FIG. 10 is a sectional view similar to FIG. 7 after the actuator is closed; and

FIG. 11 is a sectional view similar to FIG. 8 after the actuator is closed.

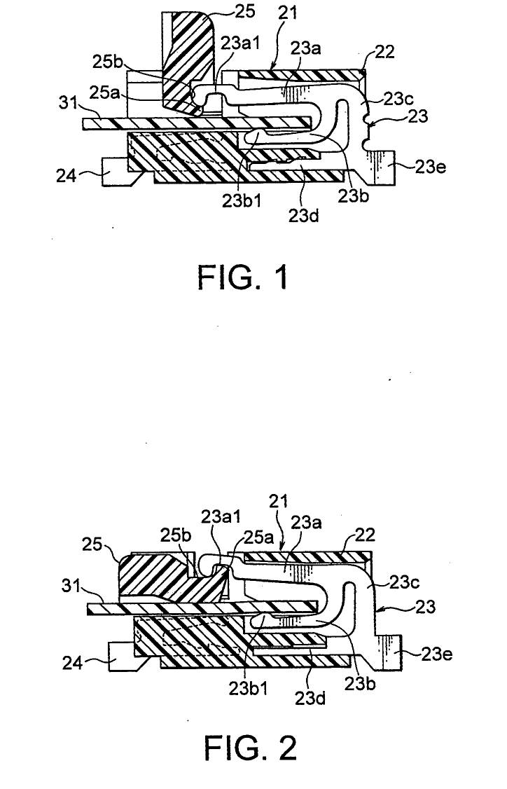

### DESCRIPTION OF THE PREFERRED EMBODIMENT

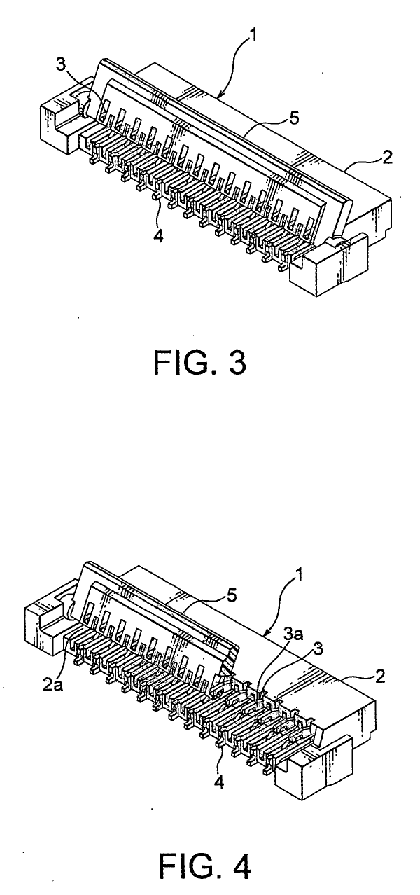

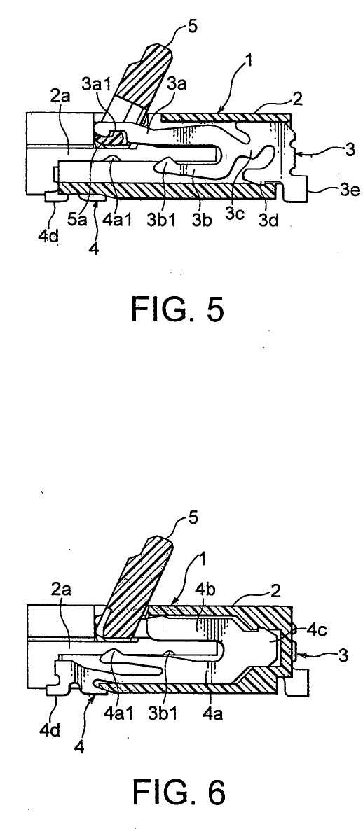

Referring to FIGS. 3 to 6, description will be made of a structure of a connector according to one embodiment of this invention.

The connector depicted at 1 in the figures comprises an insulating housing 2. The housing 2 holds a number of first contacts 3 arranged adjacent to and in parallel to one another at a predetermined pitch to form a single row and a number of second contacts 4 arranged adjacent to and in parallel to one another at a predetermined pitch to form a single row. The first and the second contacts 3 and 4 are alternately arranged. Each of the first contacts 3 has a pivot portion 3a exposed out of the housing 2.

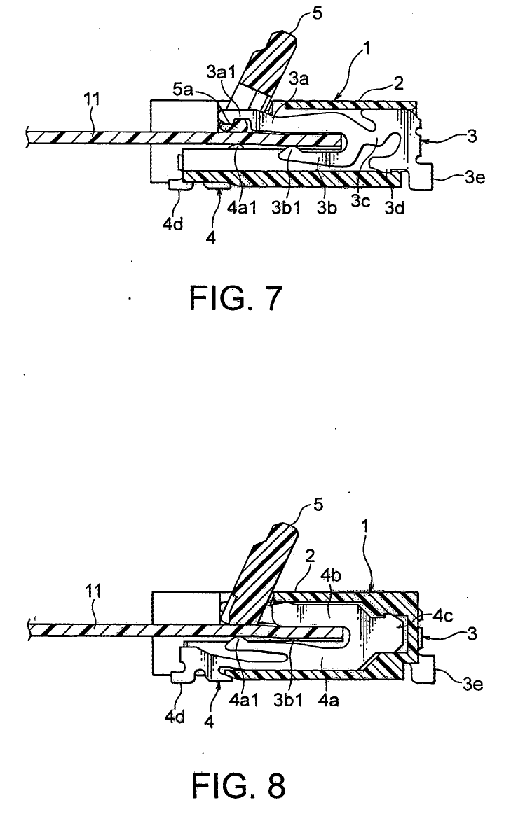

The housing 2 holds an insulating actuator 5 which is movable between an opened position and a closed position by rotation in a predetermined angular range. In FIGS. 3 to 6, the actuator 5 is in the opened position. The housing 2 has an inlet 2a for insertion of a FPC 11 (see FIGS. 7 and 8) as a connection object. The opened position and the closed position will be referred to as a disconnecting position and a connecting position, respectively.

Each of the first contacts 3 is integrally formed from a conductive material and has a pivot portion 3a, a contacting portion 3b faced to the pivot portion 3a, a connecting portion 3c elastically deformable and connected to the pivot portion 3a and the contacting portion 3b, a fixing portion 3d connected to the connecting portion 3c and fixed to the housing 2, and a terminal portion 3e connected to the fixing portion 3d. The pivot portion 3a and the contacting portion 3b extend from the connecting portion 3c as two branched parts. The pivot portion 3a has an engaging recess 3a1 formed near its end to be engaged with a cam 5a of the actuator 5. The contacting portion 3b has a contact point 3b1 formed near its end to be connected to the FPC 11. More particularly, the contact point 3b1 of the first contact 3 is located at a position corresponding to the butting portion 4b of the second contact 4 in an inserting/removing direction in which the FPC 11 is inserted and removed.

Each of the second contacts 4 is integrally formed from a conductive material and has a contacting portion 4a, a butting portion or a receiving portion 4b faced to the contacting portion 4a, a connecting portion 4c connected to the contacting portion 4a and the butting portion 4b, a fixing portion 4c fixed to the housing 2, and a terminal portion 4d extending from an intermediate position of the contacting portion 4a. The contacting portion 4a has an elastically deformable portion which extends forward from the intermediate position and has a contact point 4a1 to be press contacted with the FPC 11. The contact point 4a1 is formed near an end of the contacting portion 4a to be connected to the FPC 11. More particularly, the contact point 4a1 of the second contact 4 is located at a position corresponding to the cam 5a of the actuator 5 in the inserting/removing direction. Therefore, the contact points 3b1 and 4a1 are located to form a staggered arrangement in a direction perpendicular to the inserting/removing direction.

The contacting portion 4a is faced substantially to the pivot portion 3a of the first contact 3. It is noted here that the first and the second contacts 3 and 4 are alternately fixed to the housing 2. More specifically, the first and the second contacts 3 and 4 are shifted in position to form a staggered arrangement.

The butting portion 4b is faced to the contacting portion 3b of the first contact 3. Similarly, the butting portion 4b and the contacting portion 3b are shifted in position to form a staggered arrangement.

Referring to FIGS. 7 and 8, the FPC 11 is inserted into the connector 1 and clamped between the butting portion 4b and the contact point 4a1 of the contacting portion 4a. At this time, the actuator 5 and the cam 5a are in the opened position. When the actuator 5 is rotated counterclockwise around the engaging recess 3a1, the actuator 5 is put into the closed position.

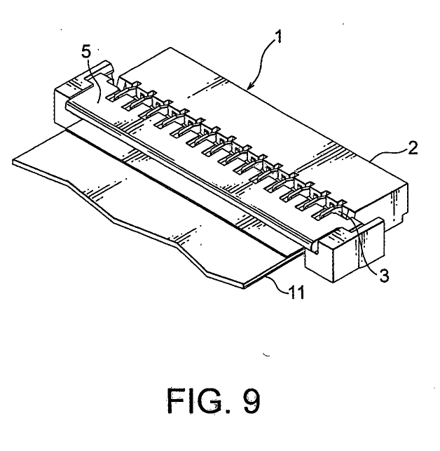

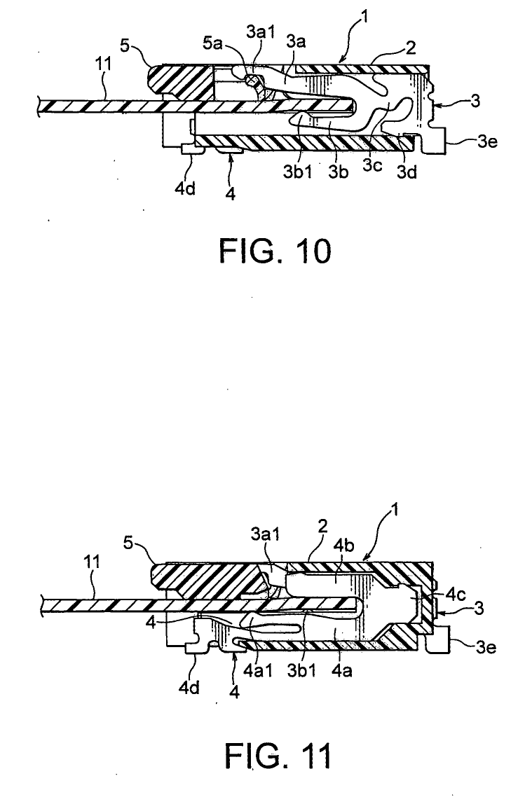

Referring to FIGS. 9 to 11, the actuator 5 and the cam 5a are in the closed position. In this event, the cam 5a of the actuator 5 pushes the pivot portion 3a of the first contact 3 upward. As a consequence, in cooperation with the pivot portion 3a, the contact point 3b1 of the contacting portion 3b of the first contact 3 is press contacted with the FPC 11.

When the cam 5a of the actuator 5 is rotated counterclockwise, the FPC 11 is pushed downward. Then, the FPC 11 presses the contact point 4a1 of the second contact 4 so that the contacting portion 4a is elastically deformed from the position in FIG. 8 to the position in FIG. 11. In the state illustrated in FIG. 11, the butting portion 4b of the second contact 4 clamps the FPC 11 in cooperation with the contact point 3b1 of the first contact 3. The contact point 3b1 of the first contact 3 and the contact point 4a1 of the second contact 4 are reliably and stably connected to the FPC 11. Thus, when the actuator 5 is in the closed position, both of the contact points 3b1 and 4b1 of the first and the second contacts 3 and 4 are press contacted with the FPC 11.

The above-mentioned connector 1 can be reduced in profile without an increase in number of components. A force of pressing the FPC 11 by the contact point 3b1 of the first contact 3 is received by the butting portion 4a1 of the second contact 4. Therefore, deformation of the housing 2 can be suppressed. Thus, connection between the first and the second contacts 3 and 4 of the connector 1 and the FPC 11 is stable.

If the butting portion 4b of the second contact 4 and a butting portion of an inner wall of the housing 2 are designed to be flush with each other, deformation of the butting portion of the inner wall of the housing 2 can be suppressed further.

While this invention has thus far been described in conjunction with the preferred embodiment thereof, it will readily be possible for those skilled in the art to put this invention into practice in various other manners. For example, the actuator 5 may be modified in design to be linearly movable. It is a matter of course that this invention is applicable to a flexible flat cable (FFC) or the like.

What is claimed is:

1. A connector comprising:
first and second contacts to be connected to a connection object;
a housing holding the first and the second contacts; and
an actuator having a cam movable with respect to the housing between a connecting position of the connection object and a disconnecting position of the connection object, the first contact having a first contacting portion with a first contact point and a pivot portion operated by the cam, the second contact having a second contacting portion with a second contact point and a butting portion faced to the second contacting portion, the butting portion clamping the connection object in cooperation with the first contact point when the connector is connected to the connection object.

2. The connector according to claim 1, wherein the first contact has a connecting portion which is elastically deformable to make the first contacting portion and the pivot portion be movable with respect to the housing.

3. The connector according to claim 2, wherein the first contact has a first fixing portion fixed to the housing, the connecting portion being connected between the first fixing portion and the pivot portion, the first contacting portion being connected to the pivot portion.

4. The connector according to claim 2, wherein the butting portion is fixed to the housing.

5. The connector according to claim 4, wherein the second contact point is movable with respect to the housing.

6. The connector according to claim 1, wherein the connection object is adapted to be inserted into and removed from the housing in an inserting/removing direction, the second contact point being located at a position corresponding to the cam in the inserting/removing direction.

7. The connector according to claim 1, wherein the first contact and the second contact are arranged adjacent to and in parallel to each other

8. The connector according to claim 1, wherein the pivot portion has a recess to be engaged with the cam.

9. The connector according to claim 1, wherein the connection object is adapted to be inserted into and removed from the housing in an inserting/removing direction, the first contact point being located at a position corresponding to the butting position in the inserting/removing direction.
